(19) United States
(12) Patent Application Publication
(10) Pub. No.: US 2025/0084958 A1
(43) Pub. Date: Mar. 13, 2025

(54) Laptop Raiser Device

(71) Applicant: Saiid Salimpour, Irvine, CA (US)

(72) Inventor: Saiid Salimpour, Irvine, CA (US)

(21) Appl. No.: 18/801,987

(22) Filed: Aug. 13, 2024

Related U.S. Application Data
(60) Provisional application No. 63/581,042, filed on Sep. 7, 2023.

(51) Int. Cl. F16M 11/20

(52) U.S. Cl. CPC F16M 11/20

(57) ABSTRACT

A laptop raiser device is disclosed as a tilting mechanism to elevate your laptop on any surface or in any environment. The laptop raiser device comprises a body component that is configured in a cylindrical shape with a flattened horizontal side to prevent it from rolling. The body component is made of a lightweight outer foam material with a non-slip surface. The body component is a single-piece or telescoping variation. The body component comprises sliding arms for holding smart devices. The body component also includes non-slip pads and carrying pouch. The laptop raiser device is available in different colors, patterns, and designs.

### CROSS-REFERENCE TO RELATED APPLICATION

The present application claims priority to, and the benefit of, U.S. Provisional Application No. 63/581,042, which was filed on Sep. 7, 2023, and is incorporated herein by reference in its entirety.

### FIELD OF THE INVENTION

The present invention relates generally to the field of laptop raiser devices (also known as Laptop Riser devices). More specifically, the present invention relates to a means for elevating a laptop on any surface and in any environment. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in laptop raiser devices. Generally, conventional laptop raisers predominantly function as mere stands, often requiring customer assembly and lacking ergonomic friendliness. These stands tend to be cumbersome, oversized, and challenging to transport, an issue exacerbated by the frequent use of laptops during travel or while on the move at work or school. The absence of a laptop raiser frequently results in uncomfortable and awkward typing and screen viewing positions. Moreover, inadequate elevation can lead to discomfort caused by the laptop's heat when placed on a person's lap. The laptop raiser device effectively addresses these concerns and more providing practical solutions that render it a valuable addition for numerous companies and laptop owners as an essential laptop peripheral with a cost-effective advantage.

Furthermore, users of laptop and other portable electronic devices have found that it is desirable to position the device at an angle with respect to the horizontal. For instance, such angle may provide more comfort when typing on a laptop keyboard, or better viewing of a display screen on the device. In the case of a tablet computer or other touch screen device, the laptop riser can provide an improved angle for writing on the touch screen. Additionally, as laptop computers and other portable electronic devices have become more powerful, they tend to generate more heat. The heat generated can result in discomfort for the user if the device is resting on the user's lap. Additionally, the heat can be detrimental to the device. Hence, it is beneficial to separate the device from the user's lap for benefit of the user and the device.

Accordingly, there is a demand for an improved laptop raiser device that elevates a laptop on any surface and in any environment. More particularly, there is a demand for a laptop raiser device that is portable and can hold-up a smart device with ease.

Therefore, there exists a long felt need in the art for a laptop raiser device that provides users with a device for elevating your laptop on any surface and in any environment. There is also a long felt need in the art for a laptop raiser device that is less expensive, lightweight, and offers the advantage of effortless portability and convenient storing. Further, there is a long felt need in the art for a laptop raiser device that is advantageous when transitioning between rooms, meetings, or moving from one class to another. Moreover, there is a long felt need in the art for a device that is available in both single-piece and telescoping variations. Further, there is a long felt need in the art for a laptop raiser device that includes an internal cavity that can be integrated to perform various complimenting functions. Finally, there is a long felt need in the art for a laptop raiser device that includes sliding arms for holding smart devices.

The subject matter disclosed and claimed herein, in one embodiment thereof, comprises a laptop raiser device. The device is a tilting mechanism to elevate your laptop on any surface or in any environment. The laptop raiser device comprises a body component that is configured in a cylindrical shape with a flattened horizontal side to prevent it from rolling. The body component is made of a lightweight outer foam material with a non-slip surface. The body component is a single-piece or telescoping variation. The body component comprises sliding arms for holding smart devices. The body component also includes non-slip pads and an internal cavity with power ports. The laptop raiser device is available in different colors, patterns, and designs.

In this manner, the laptop raiser device of the present invention accomplishes all of the forgoing objectives and provides users with a device that elevates laptops. The device can be a single-piece or telescoping. The device can comprise different colors, patterns, and designs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a laptop raiser device. The device is a tilting mechanism to elevate your laptop on any surface or in any environment. The laptop raiser device comprises a body component that is configured in a cylindrical shape with a flattened horizontal side to prevent it from rolling. The body component is made of a lightweight outer foam material. The body component is a single-piece or extendable embodiment, with multiple variations.

In one embodiment, the laptop raiser device provides a practical and intelligent design to elevate your laptop on any surface and in any environment. The laptop raiser innovative design ensures stability and comfort, even on surfaces that aren't perfectly flat, making it ideal for use in a variety of settings-from the couch to the bed or even on the go., etc. The laptop raiser device requires no assembly and offers the advantage of effortless portability and convenient storage. The laptop raiser device also allows for customization, depending on the needs and/or wants of a user.

In one embodiment, the laptop raiser device comprises a body component that is configured in an elongated cylindrical shape with a flattened horizontal side to prevent it from rolling. However, the body component can be any suitable shape and size as is known in the art, depending on the size and shape of the laptop being supported. Typically, the body component is positioned to rest on the flattened horizontal side, this prevents the body component from rolling during use. A bottom of a laptop is then placed to rest on the elongated cylindrical shape, with a bottom edge of the laptop resting on a surface. Thus, once in position, the laptop is angularly supported on the body component.

In one embodiment, the body component is a solid, one-piece construction that is sized and shaped to support a conventional laptop. In this embodiment, the body component cannot be extended or lengthened but remains in the single piece configuration.

In one embodiment, the body component is a telescoping construction that can be extended and retracted, as needed. Specifically, the body component comprises multiple sections that telescope together. If multiple telescoping sections are used, the length of the body component can be modified via a telescopic mechanism. Further, the body component comprises at least one telescoping segment that allows the total length of the body component to be extended or retracted. Each telescoping segment is hollow and has a slip lock for locking the segment at a specific length. Further, the slip lock is released by means of pressing or turning the slip lock. The at least one telescoping segments allow the body component to have a length from approximately nine inches to one and half feet fully extended, allowing a user to set the device at a desired length. Thus, the device is approximately nine inches in length but can be adjusted to a length of approximately one and half feet, if needed.

In one embodiment, the body component comprises at least one sliding/swinging arm to hold-up and display a smartphone or small tablet. The sliding arm could be telescopic or could swing or pivot, as needed. Typically, there are two sliding arms which act to prop up and display a smartphone or tablet.

In one embodiment, the laptop raiser device comprises a storage/carrying pouch that effectively holds the device and allows it to be easily transported. The storage/carrying pouch can be any suitable size and shape, as long as it can comfortably retain the laptop raiser device within.

In one embodiment, the laptop raiser device comprises at least one small, non-slip pad. Typically, there are two non-slip pads, which are secured to a front-bottom of a laptop to prevent slipping when the laptop is tilted/angled and positioned on the body component.

In one embodiment, the body component comprises an internal storage cavity, designed for convenient storage. The storage cavity comprises a lid, door or other securing means for securing the internal storage cavity. The lid or door can also have a lock, clasp, zipper, etc., or other securing means as is known in the art.

In one embodiment, the body component comprises opposing ends with integrated features, such as a port replicator, a power bank, or a Bluetooth speaker device. In this embodiment, the body component comprises an internal battery or power cord to provide power to the device, and USB ports for charging the device, as needed.

In one embodiment, the laptop raiser device is manufactured from lightweight material, durable material such as heat-scalable plastic or polymers, such as polypropylene or acrylonitrile-butadiene-styrene (ABS), or any other suitable material as is known in the art, such as but not limited to, polysiloxane, polyethylene, terephthalate, polyvinyl chloride, polystyrene, etc. Generally, the laptop raiser device is also manufactured from a material that is water resistant or waterproof, or the body component comprises a coating that is water resistant or waterproof. Furthermore, the device can be made of antibacterial or antimicrobial material or the body component comprises a coating that is antibacterial or antimicrobial.

In one embodiment, the body component of the laptop raiser device comprises a non-slip surface. The surface can be textured or rubberized, etc., or any other suitable tactile material as is known in the art.

In one embodiment, the body component can be designed in a plethora of shapes, colors, and patterns, etc. Further, companies have the option to place custom orders, tailoring the design to match their specific colors and logos, creating a complementary addition to their laptop peripheral lineup. This versatility extends further to potential collaborations with sports teams, allowing for personalized designs, featuring team logos and names. The potential for customization for all business/organization types is virtually limitless. A simple version can be designed to be used as a promotional product where any business/company/organization can place their desired logo/info on it.

In yet another embodiment, the laptop raiser device comprises a plurality of indicia.

In yet another embodiment, a method of elevating a laptop is disclosed. The method includes the steps of providing a laptop raiser device comprising a body component in a cylindrical shape with a flattened horizontal side. The method also comprises positioning the body component on its flattened side. Further, the method comprises utilizing the charge ports on the ends of the body component. The method also comprises positioning a laptop onto the body component to be elevated at an angle. Finally, the method comprises sliding out the arms to hold a smart device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the laptop raiser device of the present invention in accordance with the disclosed architecture;

FIG. 2 illustrates a perspective view of one embodiment of the laptop raiser device of the present invention showing the sliding arms to hold a smart device in accordance with the disclosed architecture;

FIGS. 3-6 illustrate a perspective view of one embodiment of the laptop raiser device of the present invention showing the single-piece and telescoping body components in accordance with the disclosed architecture;

FIGS. 7-12 illustrate a perspective view of one embodiment of the laptop raiser device of the present invention showing the storage compartment and charge ports in accordance with the disclosed architecture;

FIGS. 13-16 illustrate a perspective view of one embodiment of the laptop raiser device of the present invention showing the device in use in accordance with the disclosed architecture; and

FIG. 17 illustrates a flowchart showing the method of elevating a laptop in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a laptop raiser device that provides users with a device for elevating your laptop on any surface and in any environment. There is also a long felt need in the art for a laptop raiser device that is less expensive, lightweight, and offers the advantage of effortless portability and convenient storing. Further, there is a long felt need in the art for a laptop raiser device that is advantageous when transitioning between rooms, meetings, or moving from one class to another. Moreover, there is a long felt need in the art for a device that is available in both single-piece and telescoping variations. Further, there is a long felt need in the art for a laptop raiser device that includes an internal cavity. Finally, there is a long felt need in the art for a laptop raiser device that includes sliding arms for holding smart devices.

The present invention, in one exemplary embodiment, is a novel laptop raiser device. The device is a tilting mechanism to elevate your laptop on any surface or in any environment. The laptop raiser device comprises a body component that is configured in a cylindrical shape with a flattened horizontal side to prevent it from rolling. The body component is made of a lightweight outer foam material with a non-slip surface. The body component is a single-piece or telescoping variation. The body component comprises sliding arms for holding smart devices. The body component also includes non-slip pads and an internal cavity with power ports. The laptop raiser device is available in different colors, patterns, and designs. The present invention also includes a novel method of elevating a laptop. The method includes the steps of providing a laptop raiser device comprising a body component in a cylindrical shape with a flattened horizontal side. The method also comprises positioning the body component on its flattened side. Further, the method comprises utilizing the charge ports on the ends of the body component. The method also comprises positioning a laptop onto the body component to be elevated at an angle. Finally, the method comprises sliding out the arms to hold a smart device.

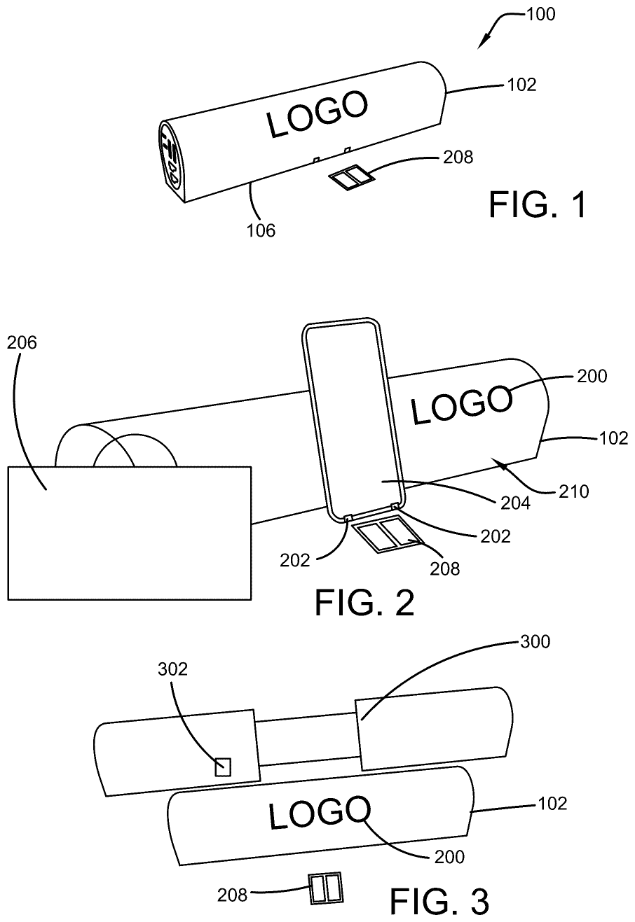

Referring initially to the drawings, FIG. 1 illustrates a perspective view of one embodiment of the laptop raiser device 100 of the present invention. In the present embodiment, the laptop raiser device 100 is an improved laptop raiser device 100 that provides a user 108 with a means for elevating a laptop 104. Specifically, the laptop raiser device 100 comprises a body component 102 in a cylindrical shape with a flattened horizontal side 106. The body component 102 is made of a lightweight outer foam material. The body component 102 is a single-piece or extendable embodiment, with multiple variations.

Generally, the laptop raiser device 100 provides a practical and intelligent design to elevate your laptop 104 on any surface and in any environment, including tables, a person's lap, or even pillows, etc. The laptop raiser device 100 requires no assembly and offers the advantage of effortless portability and convenient storage. The laptop raiser device 100 also allows for customization, depending on the needs and/or wants of a user 108.

Furthermore, the laptop raiser device 100 comprises a body component 102 that is configured in an elongated cylindrical shape with a flattened horizontal side 106 to prevent it from rolling. However, the body component 102 can be any suitable shape and size as is known in the art, depending on the size and shape of the laptop 104 being supported. Typically, the body component 102 is positioned to rest on the flattened horizontal side 106, this prevents the body component 102 from rolling during use. A bottom of a laptop 104 is then placed to rest on the elongated cylindrical shape, with a bottom edge of the laptop 104 resting on a surface. Thus, once in position, the laptop 104 is angularly supported on the body component 102.

As shown in FIG. 2, the body component 102 comprises at least one sliding/swinging arm 202 to hold-up and display a smartphone 204 or small tablet. The sliding arm 202 could be telescopic or could swing or pivot, as needed. Typically, there are two sliding arms 202 which act to prop up and display a smartphone 204 or tablet. When not in use, the sliding arms 202 can be pivoted or slid back towards the body component 102. The sliding arms 202 can be any suitable size as is known in the art, as long as they are sized to display a smartphone 204 or tablet in an upright manner.

Further, the laptop raiser device 100 comprises a storage/carrying pouch 206 that effectively holds the device 100 and allows it to be easily transported. The storage/carrying pouch 206 can be any suitable size and shape, as long as it can comfortably retain the laptop raiser device 100 within. The storage/carrying pouch 206 can be shaped as a duffel bag with a zipper/velcro or another suitable configuration as is known in the art.

Additionally, the laptop raiser device 100 comprises at least one small, non-slip pad 208. Typically, there are two non-slip pads 208, which are secured to a front-bottom of a laptop 104 to prevent the laptop 104 from slipping when the laptop 104 is tilted/angled and positioned on the body component 102. The non-slip pads 208 can be any suitable shape and size as is known in the art, as long as they act to engage the laptop 104 and prevent it from sliding down the body component 102. The non-slip pads 208 can comprise a rubberized, textured, and/or tacky surface to retain the laptop 104 and prevent it from slipping.

In one embodiment, the laptop raiser device 100 is manufactured from lightweight material, durable material such as heat-scalable plastic or polymers, such as polypropylene or acrylonitrile-butadiene-styrene (ABS), or any other suitable material as is known in the art, such as but not limited to, polysiloxane, polyethylene terephthalate, polyvinyl chloride, polystyrene, etc. Generally, the laptop raiser device 100 is also manufactured from a material that is water resistant or waterproof, or the body component 102 comprises a coating that is water resistant or waterproof. Furthermore, the device 100 can be made of antibacterial or antimicrobial material or the body component 102 comprises a coating that is antibacterial or antimicrobial.

In another embodiment, the body component 102 of the laptop raiser device 100 comprises a non-slip surface 210. The surface 210 can be tacky, textured, and/or rubberized, etc., or any other suitable tactile material or coating as is known in the art to prevent the laptop 104 from sliding off the body component 102 while in use.

In yet another embodiment, the laptop raiser device 100 comprises a plurality of indicia 200. The body component 102 of the device 100 may include advertising, a trademark, or other letters, designs, or characters, printed, painted, stamped, or integrated into the body component 102, or any other indicia 200 as is known in the art. Specifically, any suitable indicia 200 as is known in the art can be included, such as but not limited to, patterns, logos, emblems, images, symbols, designs, letters, words, characters, animals, advertisements, brands, etc., that may or may not be laptop, elevation, or brand related.

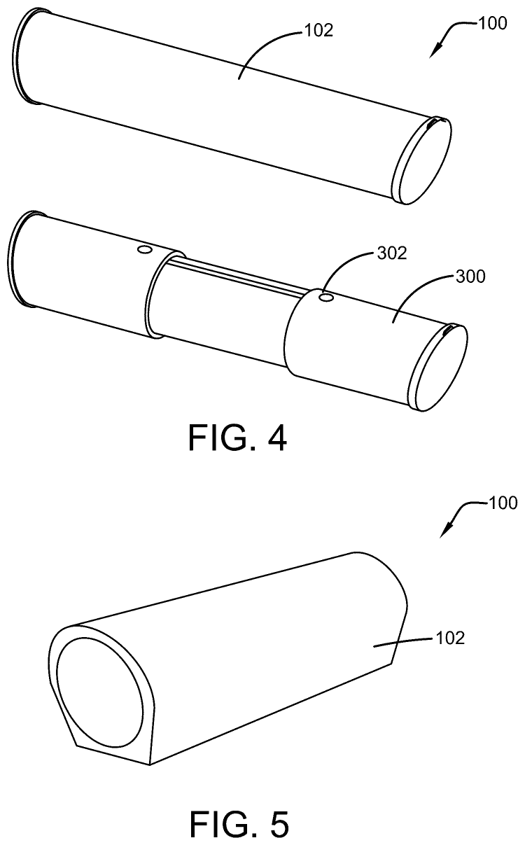

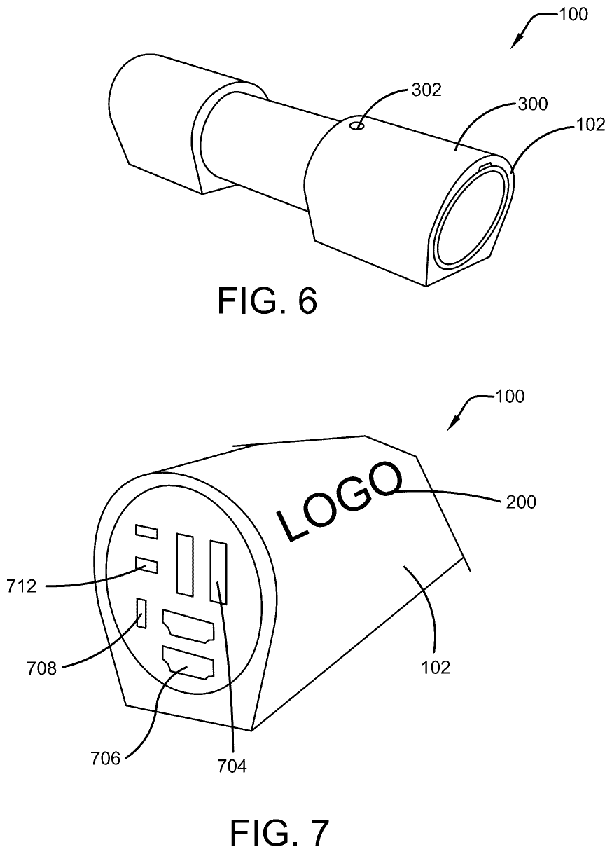

As shown in FIGS. 3-6, generally, the body component 102 is a solid, one-piece construction that is sized and shaped to support a conventional laptop 104. In this embodiment, the body component 102 cannot be extended or lengthened but remains in the single piece configuration. Typically, the body component 102 is a rod-like, elongated cylinder, but can be any suitable shape as is known in the art, depending on the needs and/or wants of a user 108.

In another embodiment, the body component 102 is a telescoping construction that can be extended and retracted, as needed. Specifically, the body component 102 comprises multiple sections 300 that telescope together. If multiple telescoping sections 300 are used, the length of the body component 102 can be modified via a telescopic mechanism. Further, the body component 102 comprises at least one telescoping segment 300 that allows the total length of the body component 102 to be extended or retracted. Each telescoping segment 300 is hollow and has a slip lock 302 for locking the segment 300 at a specific length. Further, the slip lock 302 is released by means of pressing or turning the slip lock 302. The at least one telescoping segments 300 allow the body component 102 to have a length from approximately nine inches to one and half feet fully extended, allowing a user 108 to set the device 100 at a desired length. Thus, the device 100 is approximately nine inches in length but can be adjusted to a length of approximately one and half feet, if needed.

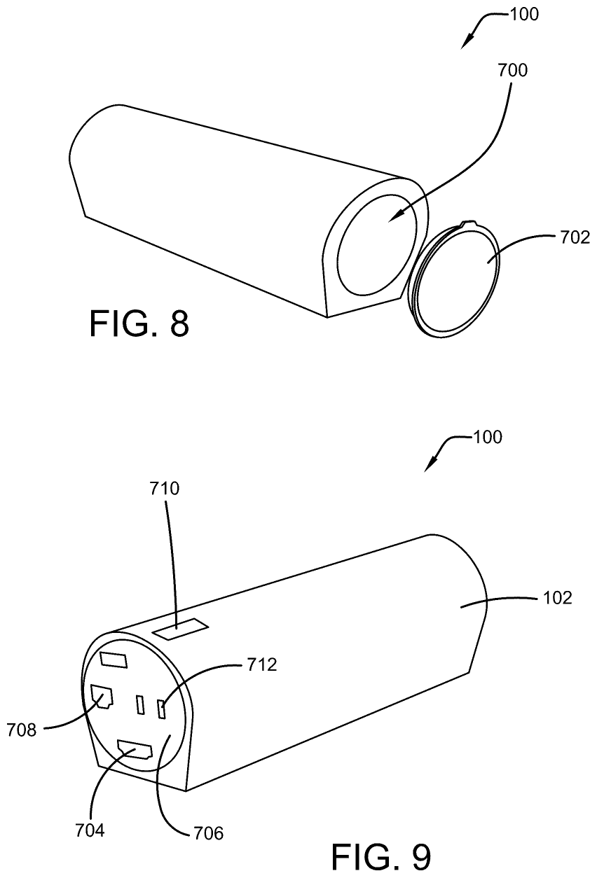

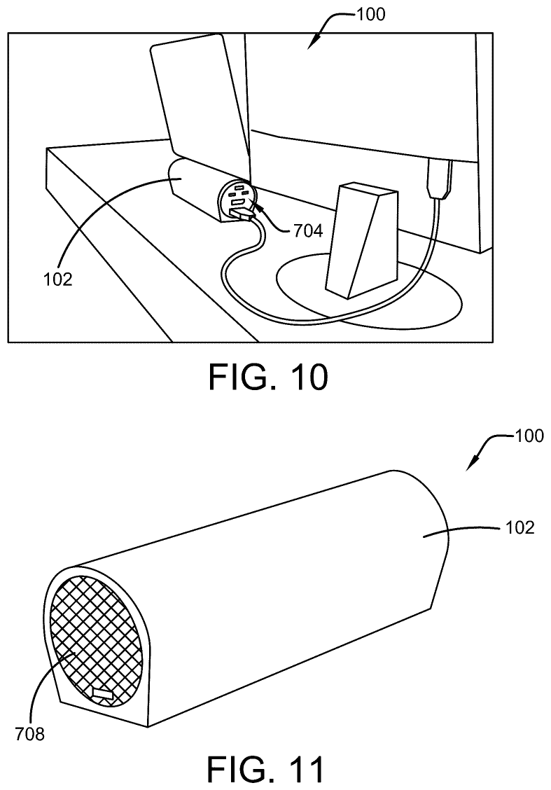

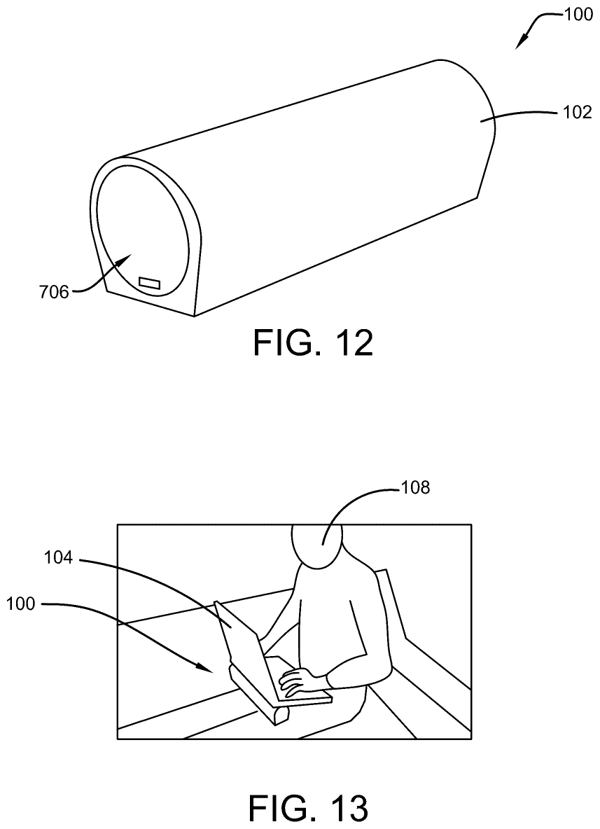

As shown in FIGS. 7-12, the body component 102 comprises an internal storage cavity 700, designed for convenient storage. The storage cavity 700 comprises a lid 702, door or other securing means for securing the internal storage cavity 700. The lid 702 or door can also have a lock, clasp, zipper, etc., or other securing means as is known in the art.

In one embodiment, the body component 102 comprises opposing ends with integrated features, such as a port replicator 704, a power bank 706, or a Bluetooth speaker device 708. In this embodiment, the body component 102 comprises an internal battery 710 or power cord to provide power to the device 100, and USB ports 712 for charging the device 100, as needed.

The internal battery 710 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the laptop raiser device 100. Throughout this specification, the term “battery” may be used interchangeably to refer to one or more wet or dry cells or batteries of cells in which chemical energy is converted into electricity and used as a source of DC power. References to recharging or replacing the battery 710 may refer to recharging or replacing individual cells, individual batteries of cells, or a package of multiple battery cells as is appropriate for any given battery technology that may be used. In addition, a rechargeable embodiment of the battery 710 may be recharged using a USB port 712, wherein the USB port 712 is a USB-A, USB-B, Micro-B, Micro-USB, Mini-USB, or USB-C port, etc.

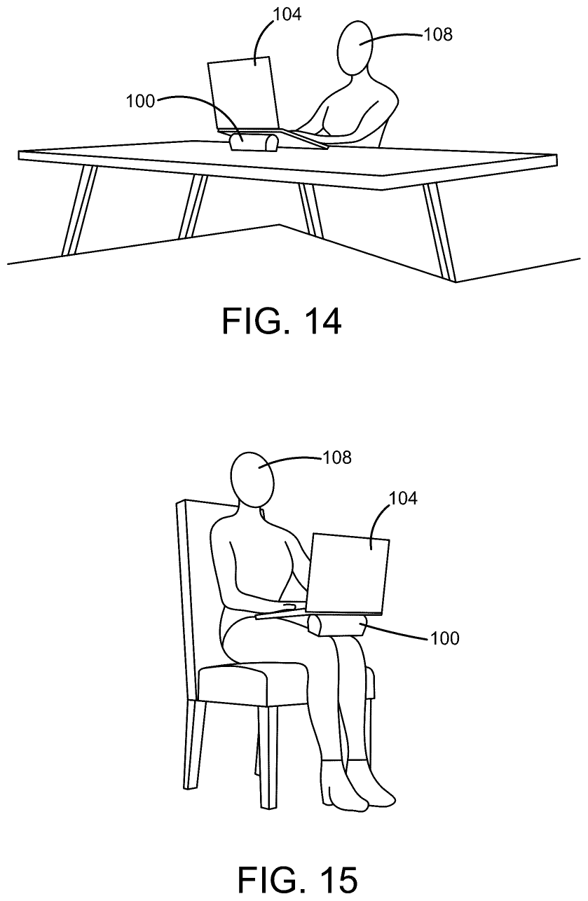

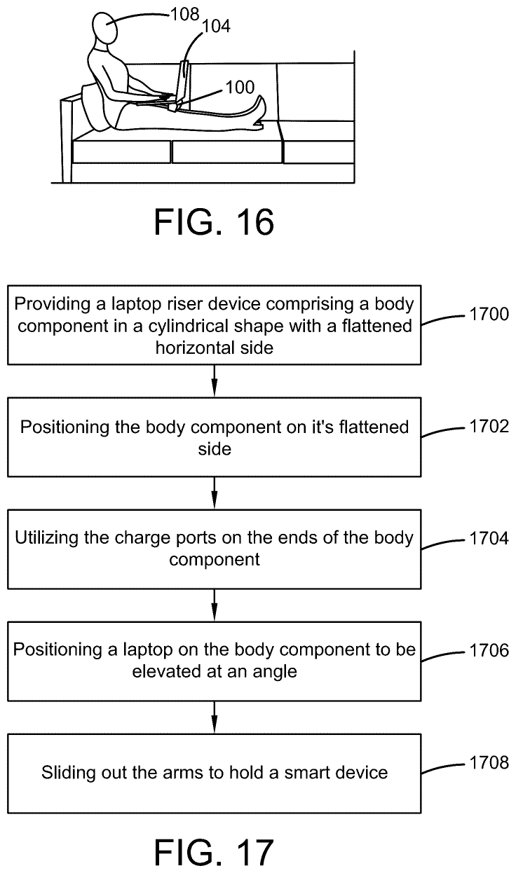

As shown in FIGS. 13-16, the body component 102 can be designed in a plethora of shapes, colors, designs, and patterns, etc. Further, companies have the option to place custom orders, tailoring the design to match their specific colors and logos, creating a complementary addition to their laptop peripheral lineup. This versatility extends further to potential collaborations with sports teams, allowing for personalized designs, featuring team logos and names. The potential for customization for all business/organization types is virtually limitless. A simple version can be designed to be used as a promotional product where any business/company/organization can place their desired logo/info on it.

FIG. 17 illustrates a flowchart of the method of elevating a laptop. The method includes the steps of at 1700 providing a laptop raiser device comprising a body component in a cylindrical shape with a flattened horizontal side. The method also comprises at 1702, positioning the body component on its flattened side. Further, the method comprises at 1704, utilizing the charge ports on the ends of the body component. The method also comprises at 1706, positioning a laptop onto the body component to be elevated at an angle. Finally, the method comprises at 1708, sliding out the arms to hold a smart device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “laptop raiser device”, “laptop device”, “raiser device”, and “device” are interchangeable and refer to the laptop raiser device 100 of the present invention.

Notwithstanding the forgoing, the laptop raiser device 100 of the present invention can be of any suitable size and configuration as is known in the art without affecting the overall concept of the invention, provided that it accomplishes the above stated objectives. One of ordinary skill in the art will appreciate that the laptop raiser device 100 as shown in FIGS. 1-17 is for illustrative purposes only, and that many other sizes and shapes of the laptop raiser device 100 are well within the scope of the present disclosure. Although the dimensions of the laptop raiser device 100 are important design parameters for user convenience, the laptop raiser device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laptop raiser device that elevates a laptop, the laptop raiser device comprising:
a body component;
wherein the body component is positioned to rest on its side on a surface;
wherein a laptop is positioned on the body component and is angularly supported by the body component; and
further wherein a bottom of the laptop is placed to rest on the side of the body component, with a bottom edge of the laptop resting on the surface.

2. The laptop raiser device of claim 1, wherein the body component is configured in a cylindrical shape with a flattened horizontal side.

3. The laptop raiser device of claim 2, wherein the body component comprises at least one sliding arm to hold-up and display a smartphone or small tablet in an upright manner.

4. The laptop raiser device of claim 3 further comprising a storage pouch for easy transport of the laptop raiser device.

5. The laptop raiser device of claim 4 further comprising at least one small, non-slip pad which secures to a front-bottom of the laptop to prevent the laptop from slipping when the laptop is positioned on the body component.

6. The laptop raiser device of claim 5, wherein the laptop raiser device is manufactured from a material that is water resistant or waterproof.

7. The laptop raiser device of claim 6, wherein the laptop raiser device is manufactured from an antibacterial or antimicrobial material.

8. The laptop raiser device of claim 7, wherein the body component comprises a non-slip surface.

9. The laptop raiser device of claim 8 further comprising a plurality of indicia.

10. The laptop raiser device of claim 9, wherein the body component is a solid, one-piece construction.

11. The laptop raiser device of claim 9, wherein the body component is a telescoping construction that can be extended and retracted.

12. The laptop raiser device of claim 9, wherein the body component comprises an internal storage cavity with a lid.

13. The laptop raiser device of claim 12, wherein the body component comprises opposing ends with integrated features, such as a port replicator, a power bank, or a Bluetooth speaker device.

14. A laptop raiser device that elevates a laptop, the laptop raiser device comprising:
a body component configured in a cylindrical shape with a flattened horizontal side; and
at least one sliding arm to hold-up and display a smartphone or small tablet in an upright manner;
wherein the body component is manufactured of a lightweight foam and comprises a non-slip surface;
wherein the body component is positioned to rest on the flattened horizontal side on a surface;
wherein the body component is a telescoping construction that can be extended and retracted;
wherein a laptop is positioned on the body component and is angularly supported by the body component;
wherein a bottom of the laptop is placed to rest on the side of the body component, with a bottom edge of the laptop resting on the surface;
wherein the body component comprises an internal storage cavity with a lid; and
further wherein the body component comprises opposing ends with integrated features, such as a port replicator, a power bank, or a Bluetooth speaker device.

15. The laptop raiser device of claim 14, wherein the body component is available in different shapes, colors, designs, and patterns.

16. The laptop raiser device of claim 14, wherein the body component comprises an internal battery.

17. The laptop raiser device of claim 16, wherein the body component comprises a USB port for charging the laptop raiser device.

18. The laptop raiser device of claim 14, wherein the body component comprises at least one telescoping segment with a slip lock which allows a total length of the body component to be extended or retracted.

19. The laptop raiser device of claim 14 further comprising at least one small, non-slip pad which secures to a front-bottom of the laptop to prevent the laptop from slipping when the laptop is positioned on the body component.

20. A method of elevating a laptop, the method comprising the following steps:
providing a laptop raiser device comprising a body component in a cylindrical shape with a flattened horizontal side;
positioning the body component on its flattened side;
utilizing the charge ports on the ends of the body component;
positioning a laptop onto the body component to be elevated at an angle; and
sliding out the arms to hold a smart device.
